(19) United States
(12) Patent Application Publication
(10) Pub. No.: US 2015/0350263 A1
(43) Pub. Date: Dec. 3, 2015

(54) METHOD OF ENHANCING INTERACTION EFFICIENCY OF MULTI-USER COLLABORATIVE GRAPHICAL USER INTERFACE (GUI) AND DEVICE THEREOF

(71) Applicant: Wipro Limited, Bangalore (IN)

(72) Inventors: Manoj Madhusudhanan, Bangalore (IN); Garima Pandey, Allahabad (IN); Sangita Ganesh, London (GB)

(21) Appl. No.: 14/339,184

(22) Filed: Jul. 23, 2014

(30) Foreign Application Priority Data
May 30, 2014 (IN) 2676/CHE/2014

(51) Int. Cl. H04L 29/06; G06F 3/0482; G06F 3/0488; G06F 3/0481

(52) U.S. Cl. CPC H04L 65/403; G06F 3/04817; G06F 3/0482; G06F 3/0488

(57) ABSTRACT

A method and device that enhances interaction efficiency of multi-user collaborative GUI. The method comprises displaying an object of interest on action area of the GUI, where the object of interest is common to plurality of users interacting with GUI. Thereafter, the one or more menu icons corresponding to one or more actions associated with object of interest are displayed. The one or more menu icons are rotatable in either clockwise or anti-clockwise directions. The method further comprises detecting selection of one or more menu icons where the selection of one or more menu icons causes processing unit to perform either: displaying one or more movable sub-menu icons corresponding to one or more actions associated with the object of interest; or executing one or more actions corresponding to the selected one or more menu icons on object of interest to obtain processed object.

This application claims the benefit of U.S. Indian Patent Application Serial No. 2676/CHE/2014 filed May 30, 2014, which is hereby incorporated by reference in its entirety.

### FIELD

This technology is related, in general to graphical user interface (GUI), and more particularly, but not exclusively to a method and device for enhancing interaction efficiency of a multi-user collaborative GUI.

### BACKGROUND

The digital display systems and multi-user interface technologies, particularly multi-touch systems, create a practical environment for rich collaborative workspaces, in which two or more users may work side-by-side at the same display. In the multi-touch systems there is a need for users to interact by neither affecting other simultaneous user interactions nor changing orientation and position of the display system in order to facilitate efficient collaboration.

Currently, most of the multi-user interface designs that exist do not enable efficient collaboration as they are designed based on the method used for single user interactions in single user devices. If the design concept used for multi user devices is same as the design concept used for single user devices, then the other users simultaneously using the multi-user interface lose their interaction efficiency with the multi-user interface. The interaction efficiency for single user using smaller interfaces is generally high, whereas in large multi-user devices there is a need to improve the interaction efficiency for each user interacting with the interface.

The conventional methods for enhancing interaction efficiency of the multi-user interface such as auto orientation, orientation freeze etc. attempt to address the abovementioned issues but fail to consider the interaction efficiency and functionality independence of each user in the multi-user interface scenario.

Therefore, there is a need to improve the interaction efficiency of the multi-user interface without having fixed/rigid interaction functionalities, thereby enabling multiple users to interact with the interface without affecting other user's interactions.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Accordingly, a method for enhancing interaction efficiency of multi-user collaborative graphical user interface (GUI) includes displaying an object of interest on an action area of the GUI. The object of interest is common to plurality of users interacting with the GUI. Upon displaying the object of interest, one or more menu icons corresponding to one or more actions associated with the object of interest are displayed. The one or more menu icons are rotatable in at least one of clockwise and anti-clockwise directions. The method may further comprise detecting a selection of the one or more menu icons by one of the plurality of users. The selection of the one or more menu icons causes the processing unit to perform at least one of displaying one or more movable sub-menu icons corresponding to one or more actions associated with the object of interest or executing the one or more actions corresponding to the selected one or more menu icons on the object of interest to obtain a processed object.

Further, the present disclosure relates to a multi-user collaborative graphical user interface (GUI) for a device. The GUI comprising an action area configured to display an object of interest, wherein the object of interest is common to plurality of users interacting with the GUI and one or more menu icons corresponding to one or more actions associated with the object of interest, wherein the one or more menu icons are rotatable in at least one of clockwise and anti-clockwise directions.

Furthermore, the present disclosure relates to device for enhancing interaction efficiency of multi-user collaborative graphical user interface (GUI). The device comprising a multi touch screen display to receive a touch of an input element on the GUI displayed on the touch screen display and at least one processing unit. The device further comprises a memory storing instructions executable by the at least one processing unit, wherein the instructions configure the at least one processing unit to display an object of interest on an action area of the GUI configured in the touch screen display, wherein the object of interest is common to plurality of users interacting with the GUI. The processor is further configured to display one or more menu icons corresponding to one or more actions associated with the object of interest, wherein the one or more menu icons are rotatable in at least one of clockwise and anti-clockwise directions. Upon displaying the one or more menu icons, the processing unit is further configured to detect selection of the one or more menu icons by the plurality of users. The selection of one or more menu icons causes the processing unit to perform at least one of displaying one or more movable sub-menu icons corresponding to one or more actions associated with the object of interest or executing the one or more actions corresponding to the selected one or more menu icons on the object of interest to obtain a processed object.

Furthermore, the present disclosure relates to a non-transitory computer readable medium including operations stored thereon that when processed by at least one processor cause a device to perform the acts of displaying an object of interest on an action area of the GUI, wherein the object of interest is common to plurality of users interacting with the GUI. Upon displaying the object of interest, the processing unit further causes the device to display one or more menu icons on the GUI, wherein the one or more menu icons are rotatable in at least one of clockwise and anti-clockwise directions. The processing unit further causes the device to detect selection of the one or more menu icons by the plurality of users. Upon detecting the selection of the one or more menu icons, the processing unit causes the device to perform at least one of displaying one or more movable sub-menu icons corresponding to one or more actions associated with the object of interest or executing the one or more actions corresponding to the selected one or more menu icons on the object of interest to obtain a processed object.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates a block diagram of a device in accordance with some embodiments of the present disclosure;

FIGS. 2a-2b illustrates a block diagram of an exemplary multi-user collaborative graphical user interface (GUI) in accordance with some embodiments of the present disclosure;

FIGS. 3a-3b illustrates a block diagram of another exemplary multi-user collaborative GUI in accordance with some embodiments of the present disclosure;

FIGS. 4a-4d illustrates an exemplary environment for enhancing interaction efficiency of a multi-user collaborative GUI in accordance with some embodiments of the present disclosure;

FIGS. 5a-5d illustrates another exemplary environment for enhancing interaction efficiency of a multi-user collaborative GUI in accordance with some embodiments of the present disclosure;

FIGS. 6a-6g illustrates a method for enhancing interaction efficiency of a multi-user collaborative GUI in accordance with some exemplary embodiments of the present disclosure; and

FIG. 7 illustrates a flowchart of method of enhancing interaction efficiency of a multi-user collaborative GUI in accordance with some embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Accordingly, the present disclosure relates to method and device for enhancing interaction efficiency of a multi-user collaborative interface. The method includes, displaying an object of interest on an action area of the GUI. The object of interest depends on the application being executed in the device. Based on the application being executed in the device, the processing unit configured in the device identifies the object of interest and displays the object of interest on an action area of the GUI. The object of interest is common to plurality of users interacting with the GUI. Upon displaying the object of interest, the processing unit display one or more menu icons on the GUI. The one or more menu icons may be displayed on at least one of boundary of the action area and periphery of the action area. The one or more menu icons correspond to one or more actions associated with the object of interest. The one or more menu icons are rotatable in at least one of clock-wise direction and anti-clockwise direction. Since the one or more menu icons are rotatable, the GUI orients itself to the specific needs of the users without obstructing other user's interactions with the GUI. The users may select one or more menu icons.

The processing unit detects the selection of the one or more menu icons and based on the selection of one or more menu icons the processing unit identifies whether the selected one or more menu icons are associated with one or more movable sub-menu icons. If the selected one or more menu icons are associated with one or more movable sub-menu icons, the processing unit displays the one or more movable sub-menu icons on the GUI. If the selected one or more menu icons is not associated with one or more movable sub-menu icons, the processing unit executes the one or more actions associated with the selected one or more menu icons on the object of interest to obtain a processed object. The processed object may be displayed on the action area of the GUI. In some embodiments, the processed object may be displayed on either of the side panel area configured in the GUI.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

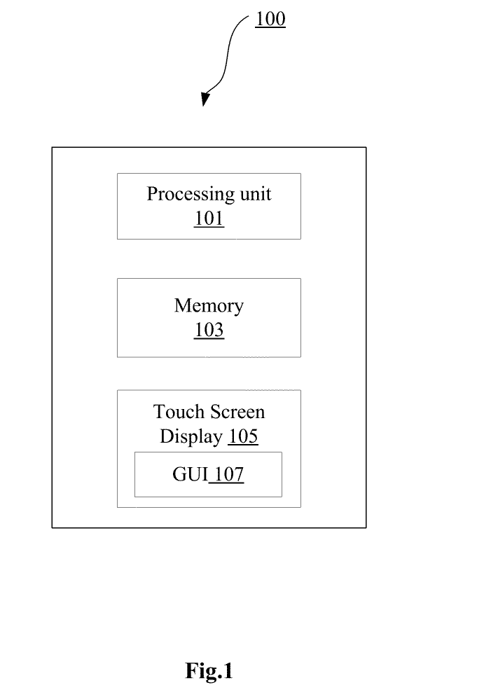

FIG. 1 illustrates a block diagram of a device 100 in accordance with some embodiments of the present disclosure.

As shown in FIG. 1, the device 100 may include a processing unit 101, a memory 103 and a touch screen display 105. Examples of the device include, but not limited to, a touch screen computer, a tablet, a touch screen mobile device, a touch pad, car navigation systems, medical monitors, industrial control panels and any other processing device having touch screen panel. The device 100 may be configured to execute one or more applications. The one or more applications may include, but not limited to, a gaming application, ring-tone application, banking application and so on. A graphical user interface (GUI) 107 configured in the touch screen display 105 dynamically changes based on the type of application being executed in the device 100.

In one implementation, the processing unit 101 may comprise at least one data processor for executing program components and for executing user- or system-generated requests. A user may include a person, a person using the device such as those included in this disclosure, or such a device itself. The processing unit 101 may include specialized processing units such as integrated system (bus) controllers, memory management control units, floating point units, graphics processing units, digital signal processing units, etc. The processing unit may include a microprocessor, such as AMD Athlon, Duron or Opteron, ARM's application, embedded or secure processors, IBM PowerPC, Intel's Core, Itanium, Xeon, Celeron or other line of processors, etc. The processing unit 101 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc. Among other capabilities, the processing unit 101 is configured to fetch and execute computer-readable instructions stored in the memory 103. The memory 103 can include any non-transitory computer-readable medium known in the art including, for example, volatile memory (e.g., RAM), and/or non-volatile memory (e.g., EPROM, flash memory, etc.).

In some implementation, the touch screen display 105 may be configured to receive a touch of an input element on the GUI 107 displayed on the touch screen display 105. Examples of the input element includes, but are not limited to, stylus, finger, pen shaped pointing device, and any other device that can be used to provide input through a touch screen interface. The touch screen display is a multi-touch screen display configured to receive input from multi-users. The touch screen display 105 is coupled with the processing unit 101 and an I/O device. The I/O device is configured to receive inputs from one or more users via the GUI and transmit outputs for displaying in the I/O device via the GUI.

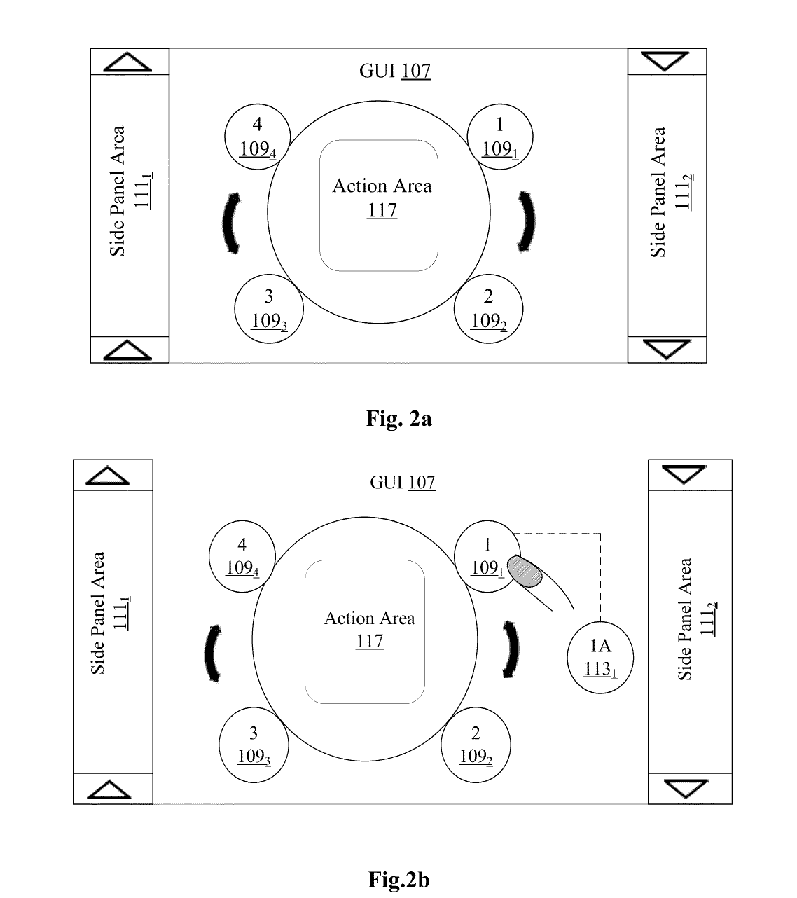

FIGS. 2a-2b illustrates a block diagram of an exemplary multi-user collaborative graphical user interface GUI 107 in accordance with some embodiments of the present disclosure.

As shown in FIG. 2a the GUI 107 may include an action area 117, one or more menu icons, menu icon 1 109₁, menu icon 2 109₂, menu icon 3 109₃ and menu icon 4 109₄ (collectively referred as 109) and at least one side panel area 111. In one implementation, the GUI 107 is configured with two side panel areas, the first side panel area 111₁ configured on left hand side of the GUI 107 and the second side panel area 111₂ configured on right hand side of the GUI 107. In some alternative embodiments, number of side panel areas configured in the GUI 107 may be varied based on the requirement.

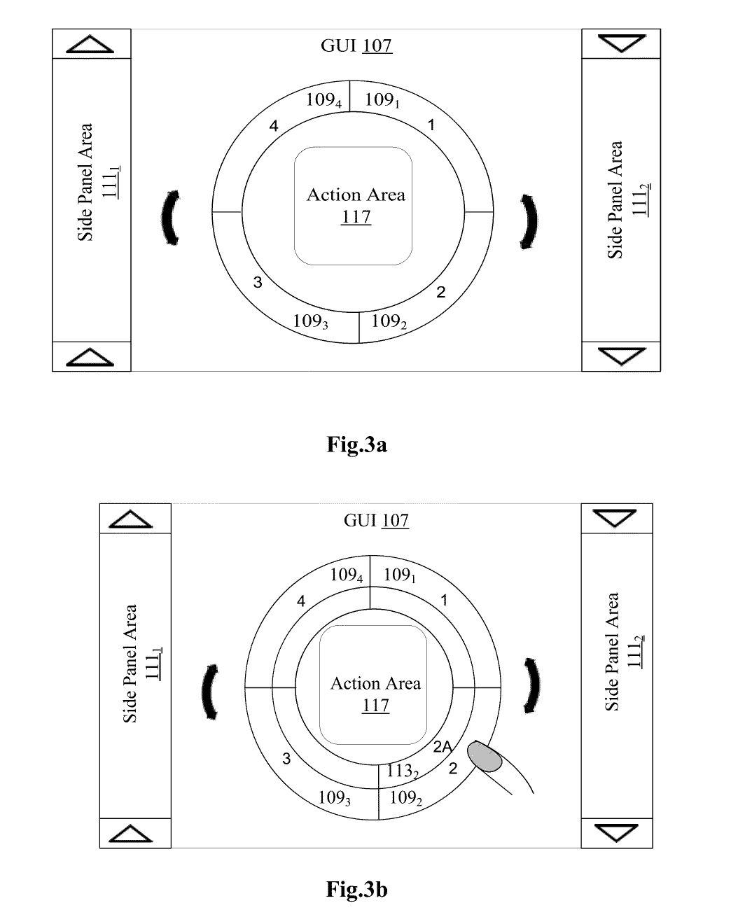

The processing unit 101 displays an object of interest on the action area 117. The object of interest is defined herein as an object being common to plurality of users interacting with the device 100. The object of interest depends on the application being executed in the device 100. For example, the object of interest may include but not limited to, a drawing canvas for a drawing application, banking offers available in a banking application and so on. The GUI 107 dynamically changes based on the application being executed in the device 100. The object of interest is associated with one or more actions. For example, if the object of interest is a drawing canvas, then the one or more actions may include, but are not limited to, applying pencil effect for the drawing, applying shades to the drawing, providing color combinations to the drawing and so on. Similarly, if the object of interest is banking offers for a banking application, then the one or more actions may include, but are not limited to, Equated Monthly Installments (EMI) offers, housing loan, vehicle loan and so on. In some embodiments, the one or more menu icons 109 correspond to one or more actions associated with the object of interest. In some other embodiments, the one or more menu icons 109 are further associated with one or more movable sub-menu icons (best shown in FIG. 2b) and the one or more movable sub-menu icons correspond to one or more actions associated with the object of interest. In one embodiment, the processing unit 101 may display the one or more menu icons 109 on boundary of the action area (best shown in FIG. 3a). In some other embodiments, the processing unit 101 may display the one or more menu icons 109 on the periphery of the action area (as shown in FIG. 2a and FIG. 2b).

As shown in FIG. 2a, the one or more menu icons 109 are displayed on the periphery of the action area. The shape of the one or more menu icons 109 may include, but not limited to, circular, oval, rectangular, and any other shapes which meets the requirement. In some embodiments, the one or more menu icons 109 are rotatable in either clock-wise direction or anticlockwise direction. Since the one or more menu icons 109 are rotatable, the users don't have to move around the GUI 107 in order to access the one or more menu icons 109. The users may rotate the one or more menu icons 109 so that the one or more menu icons 109 are near the position of the user for selection.

In operation, the user may select the menu icon 1 109₁ as shown in FIG. 2b. The processing unit 101 detects the selection of the menu icon 1 109₁. If the selected menu icon 1 109₁ is associated with one or more movable sub-menu icons, the processing unit 101 displays the one or more movable sub-menu icons on the GUI 107. The one or more movable sub-menu icons are movable across the GUI 107. The processing unit 101 identifies that the selected sub-menu icon icon 1 109₁ is associated with the movable sub-menu icon 1A 113₁. The processing unit 101 displays the movable sub-menu icon 1A 113₁ on the GUI 107. The user may select the movable sub-menu icon 1A 113₁. The processing unit 101 detects the selection of the movable sub-menu icon 1A 113₁ and applies the action corresponding to the selected movable sub-menu icon 1A 113₁ on the object of interest. Thereafter, the processing unit 101 processes the object of interest based on the applied action to obtain a processed object. If the selected menu icon 1 109₁ is not associated with one or more movable sub-menu icons, then the processing unit 101 executes the action associated with the selected menu icon 1 109₁ on the object of interest to obtain a processed object.

In some embodiments, the processing unit 101 may display the processed object on at least one of the side panel area 111. In one implementation, the processed object displayed on the side panel area is orientable in one or more directions depending on the position of the users interacting with the GUI 107.

FIGS. 3a-3b illustrates a block diagram of another exemplary multi-user collaborative graphical user interface GUI 107 in accordance with some embodiments of the present disclosure.

As shown in FIG. 3a, the one or more menu icons, menu icon 1 109₁, menu icon 2 109₂, menu icon 3 109₃ and menu icon 4 109₄ are displayed on the boundary of the action area 117. The shape of the one or more menu icons may include, but not limited to, circular. In some embodiments, the one or more menu icons 109 are rotatable in either clock-wise direction or anticlockwise direction. Since the one or more menu icons are rotatable, the users don't have to move around the GUI 107 in order to access the menu icons 109. Upon receiving the signal from the users, the processing unit 101 rotates the one or more menu icons 109 so that the menu icons 109 are at the required position on the GUI 107 for user selection. As an example, the user may select the menu icon 2 109₂. The processing unit 101 detects the selection of the menu icon 2 109₂. Thereafter, the processing unit 101 may either display the one or more movable sub-menu icons associated with the selected menu icon 2 109₂ or execute the action associated with the selected menu icon 2 109₂.

As shown in FIG. 3b, the processing unit 101 displays the one or more sub-menu icons associated with the selected menu icon 2 109₂ on the GUI 107. The sub-menu icons associated with the selected menu icon 2 109₂ is a movable sub-menu icon 2A 113₂. The processing unit 101 may display the sub-menu icon 2A 113₂ on the GUI 107. The user may select the sub-menu icon 2A 113₂. The processing unit 101 detects the selection of the sub-menu icon 2A 113₂ and applies the action corresponding to the selected sub-menu icon 2A 113₂ on the object of interest. Thereafter, the processing unit 101 processes the object of interest based on the applied action to obtain a processed object. In some embodiments, the processing unit 101 may display the processed object on at least one of the side panel area 111. In one implementation, the processed object displayed on the side panel area 111 is orientable in one or more directions depending on the position of the users interacting with the GUI 107.

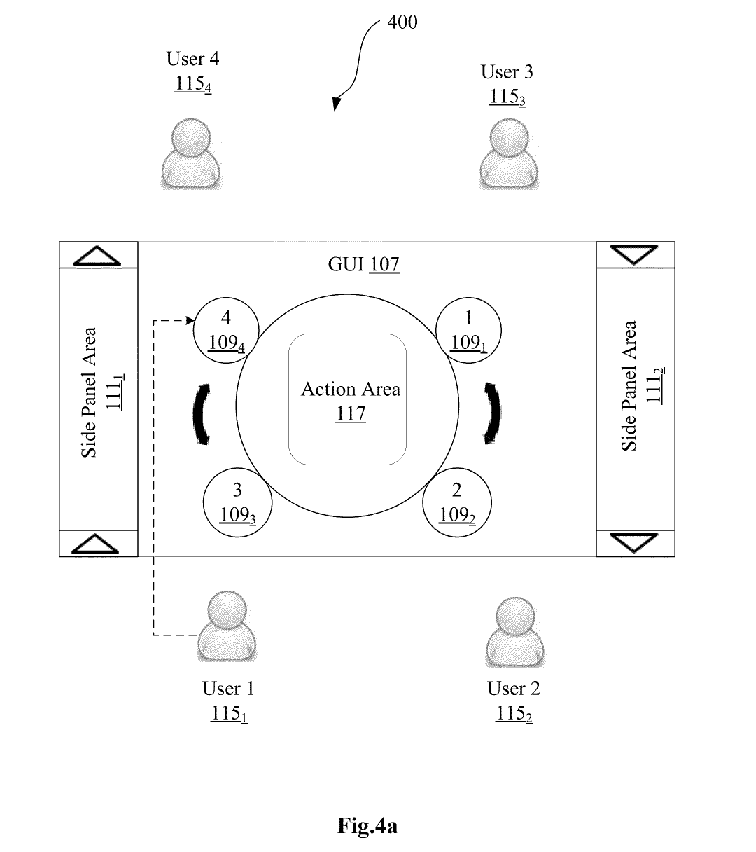

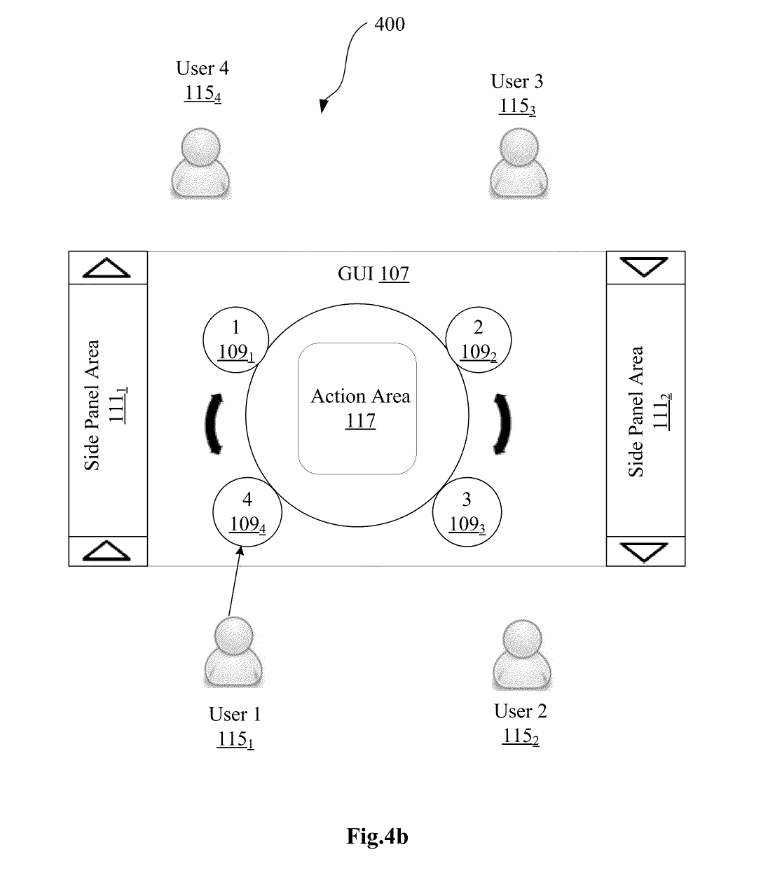

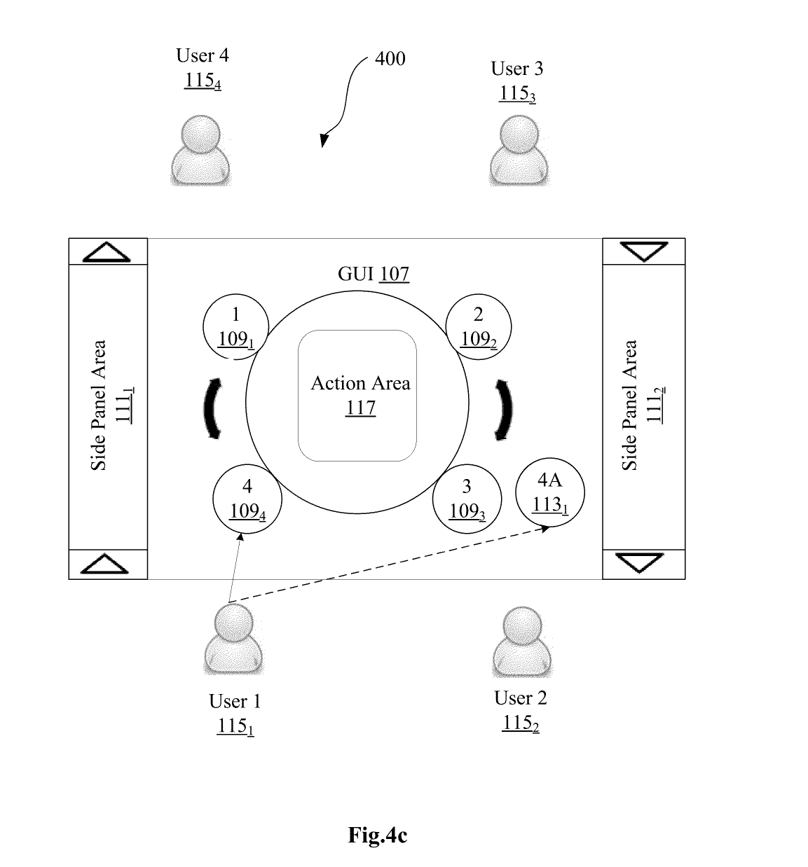

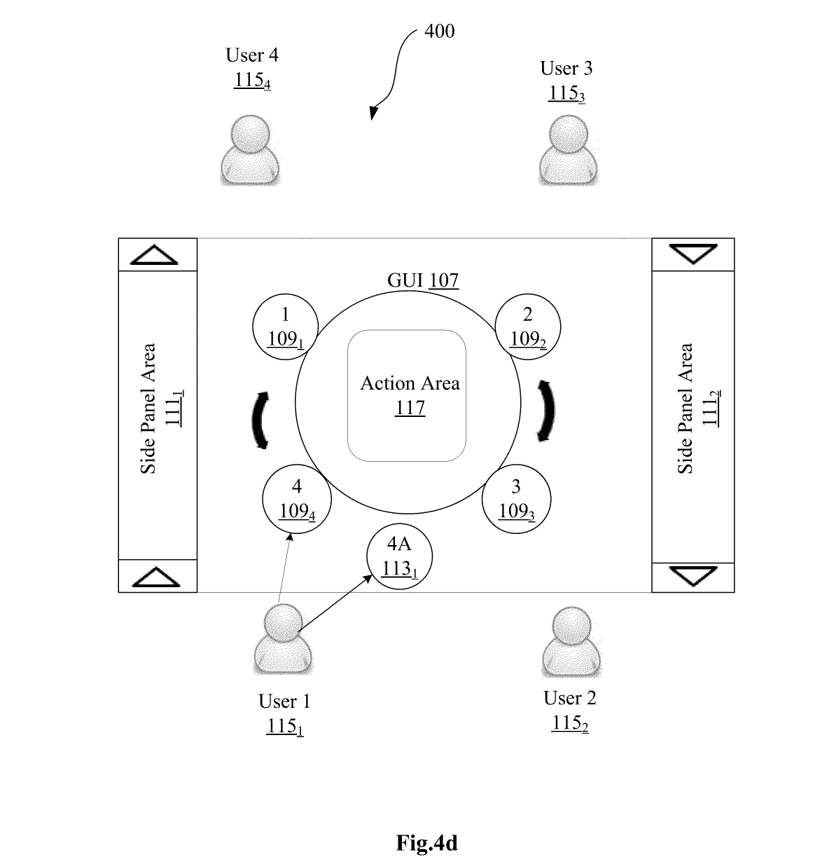

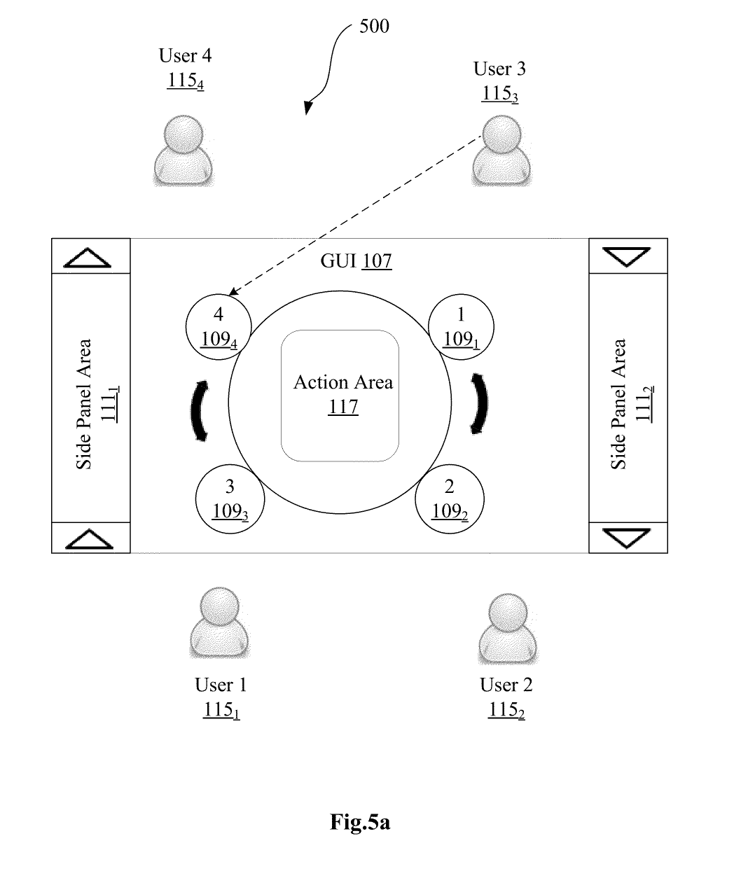

FIGS. 4a-4d illustrates an exemplary environment for enhancing interaction efficiency of a multi-user collaborative GUI 107 in accordance with some embodiments of the present disclosure.

As shown in FIG. 4a, the environment 400 may include one or more users, user 1 115₁, user 2 115₂, user 3 115₃, user 4 115₄ (collectively referred as users 115) interacting with the multi-user collaborative GUI 107.

In operation, the processing unit 101 displays an object of interest which is common to the users 115 interacting with the GUI 107 on the action area 117. The processing unit 101 also displays one or more menu icons, menu icon 1 109₁, menu icon 2 109₂, menu icon 3 109₃ and menu icon 4 109₄ associated with the object of interest on the periphery of the action area 117. For example, the user 1 115₁ may intend to select the menu icon 4 109₄. The menu icon 4 109₄ is away from the reach of the user 1 115₁. In order to reach the menu icon 4 109₄, the user 1 115₁ provides a signal and the processing unit 101 may rotate the one or more menu icons 109 in either clockwise direction or anti-clockwise direction such that the menu icon 4 109₄ is near the position of the user 1 115₁. In one embodiment, the signal may be instruction provided to the processing unit 101 to rotate the one or more menu icons 109 in clockwise direction or anti-clockwise direction. The user would decide whether the one or more menu icons 109 must be rotated either in clockwise direction or anti-clockwise direction based on the distance between the user and the particular menu icon 109.

As shown in FIG. 4b, the processing unit 101 rotates the one or more menu icons 109 in anti-clockwise direction such that the menu icon 4 109₄ is towards the position of the user 1 115₁.

As shown in FIG. 4c, the user may select the menu icon 4 109₄. The processing unit 101 detects the selection of the menu icon 4 109₄. Thereafter, the processing unit 101 determines if there are one or more movable sub-menu icons associated with the selected menu icon 4 109₄. If the menu icon 4 109₄ is not associated with one or more movable sub-menu icons, the processing unit 101 may execute the action corresponding to the selected menu icon 4 109₄ on the object of interest to obtain a processed object. The processed object may be displayed on the action area 117. In some other embodiments, the processed object may be displayed on either of the side panel area 111.

In one implementation, the processing unit 101 determines that the sub-menu icon 4A 113₄ is associated with the selected menu icon 4 109₄. The processing unit 101 displays the sub-menu icon 4A 113₄ on the GUI 107. In one implementation, the movable sub-menu icons are movable across the GUI 107. Upon receiving the signal from the user 1 115₁, the processing unit 101 may move the sub-menu icon 4A 113₄ near the user 1 115₁.

As shown in FIG. 4d, the processing unit 101 moves the sub-menu icon 4A 113₄ near the user 1 115₁. In operation, when the user 1 115₁ selects the sub-menu icon 4A 113₄, the processing unit 101 detects the selection of the movable sub-menu icon 4A 113₄ and applies the action associated with the selected sub-menu icon 4A 113₄ on the object of interest. In some embodiments, if there is more than one sub-menu icons, the user 1 115₁ may switch between the one or more menu icons to apply different actions on the object of interest. The processing unit 101 may process the object of interest based on the applied action to obtain the processed object. The processed object may be displayed on the action area 117. In some other embodiments, the processed object may be displayed on either of the side panel area 111.

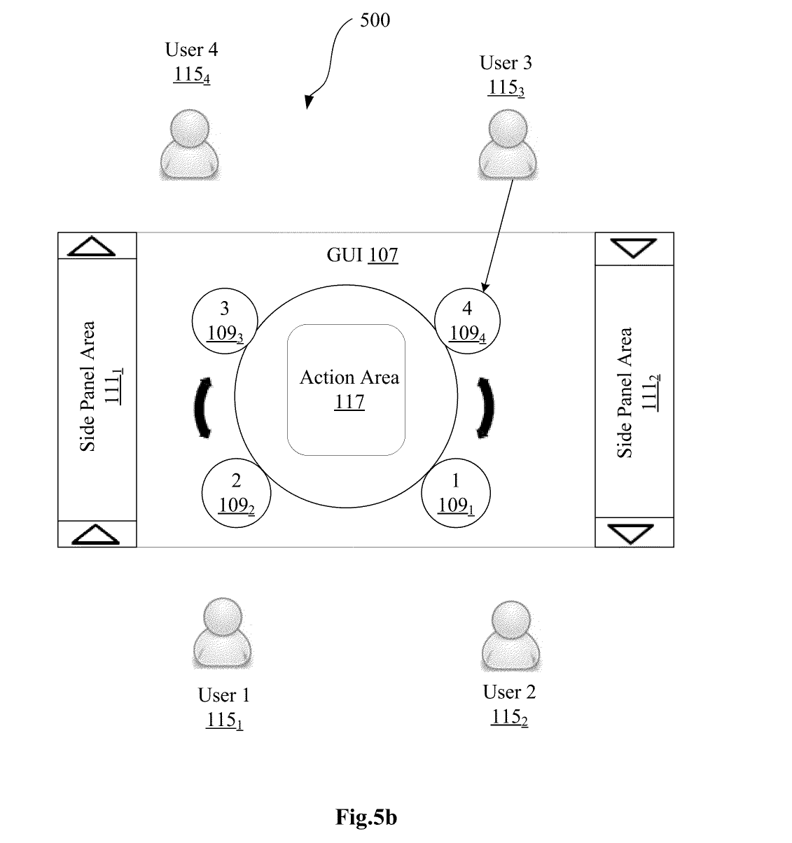

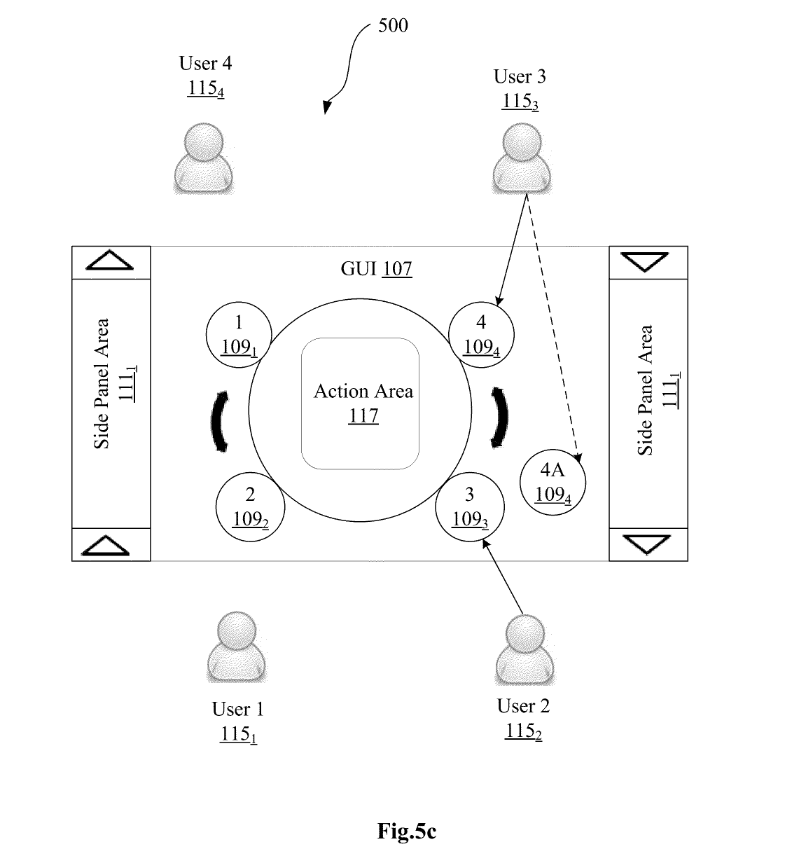

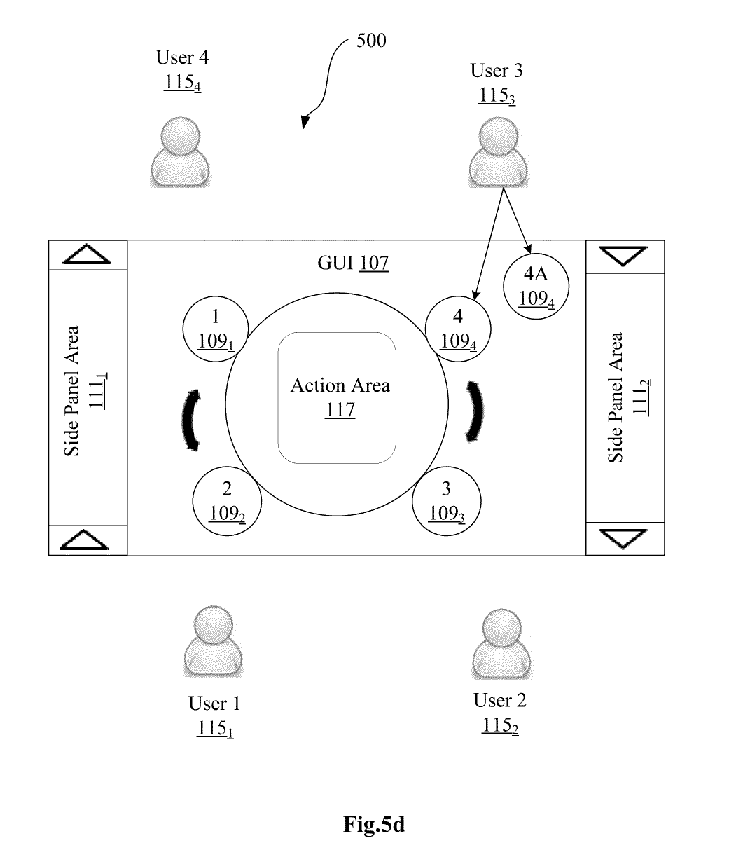

FIGS. 5a-5d illustrates another exemplary environment 500 for enhancing interaction efficiency of a multi-user collaborative GUI 107 in accordance with some other embodiments of the present disclosure.

As shown in FIG. 5a, the environment 500 may include one or more users, user 1 115₁, user 2 115₂, user 3 115₃, user 4 115₄ (collectively referred as users 115) interacting with the multi-user collaborative GUI 107.

In operation, the processing unit 101 may display an object of interest which is common to the users on the action area 117. The processing unit 101 also displays one or more menu icons, menu icon 1 109₁, menu icon 2 109₂, menu icon 3 109₃ and menu icon 4 109₄ associated with the object of interest on the periphery of the action area 117. For example, the user 3 115₃ may intend to select the menu icon 4 109₄. The menu icon 4 109₄ is away from the reach of the user 3 115₃. In order to reach the menu icon 4 109₄, the user 3 115₃ may rotate the one or more menu icons in either clockwise direction or anti-clockwise direction such that the menu icon 4 109₄ is near the user 3 115₃.

As shown in FIG. 5b, the processing unit 101 rotates the one or more menu icons 109 in clockwise direction such that the menu icon 4 109₄ is near the user 3 115₃.

As shown in FIG. 5c, the user 3 115₃ may select the menu icon 4 109₄. Simultaneously, the user 2 115₂ may select the menu icon 3 109₃. The processing unit detects the selection of the menu icons, menu icon 4 109₄ and menu icon 3 109₃. Thereafter, the processing unit 101 determines if there are one or more movable sub-menu icons 113 associated with the selected menu icons, menu icon 4 109₄ and menu icon 3 109₃. In one embodiment, the processing unit 101 identifies that the menu icon 3 109₃ is not configured with one or more movable sub-menu icons 113. Therefore, the processing unit 101 applies the action associated with the selected menu icon3 109₃ on the object of interest to obtain a processed object. The processed object may be displayed on the action area 117. In some other embodiments, the processed object may be displayed on either of the side panel area 111.

In other embodiment, the processing unit 101 determines that the movable sub-menu icon 4A 109₄ is associated with the selected menu icon 4 109₄. The processing unit 101 displays the movable sub-menu icon 4A 109₄ on the GUI 107 as shown in FIG. 5c. In one implementation, the movable sub-menu icons are movable across the GUI 107. The user 3 115₃ may move the movable sub-menu icon across the GUI 107.

As shown in FIG. 5d, the user 3 115₃ moves the movable sub-menu icon 4A 109₄ towards the position of the user 3 115₃. In operation, when the user 3 115₃ selects the movable sub-menu icon 4A 109₄, the processing unit 101 detects the selection of the movable sub-menu icon 4A 109₄ and applies the action associated with the selected movable sub-menu icon 4A 109₄ on the object of interest. In some embodiments, if there are more than one movable sub-menu icons, the user 3 115₃ may switch between the one or more movable sub-menu icons to apply different actions on the object of interest. The processing unit 101 may process the object of interest based on the applied action to obtain the processed object. The processed object may be displayed on the action area. In some other embodiments, the processed object may be displayed on either of the side panel area 111.

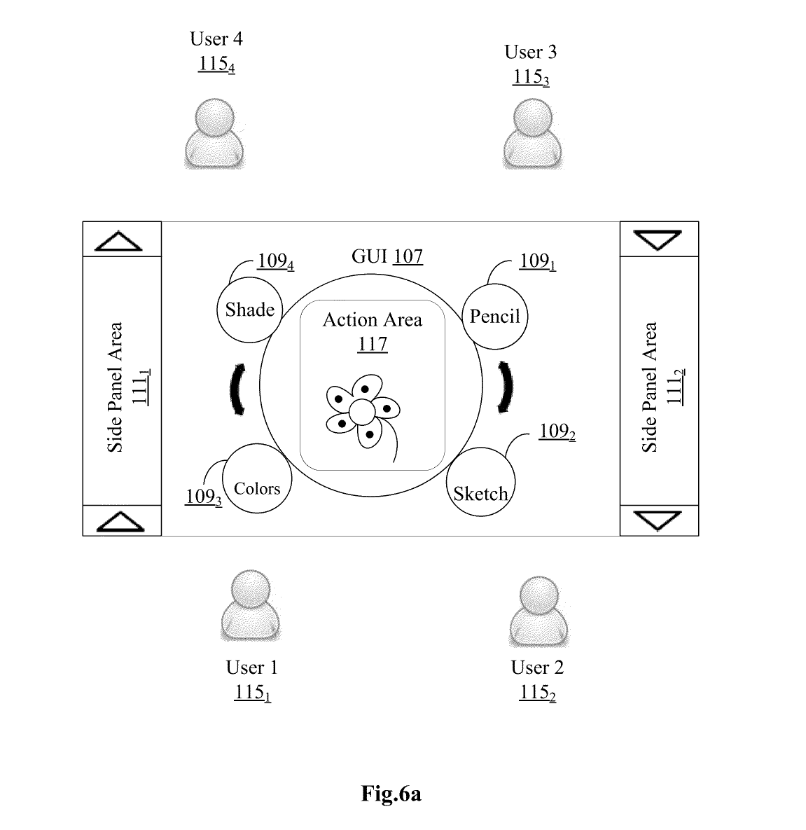

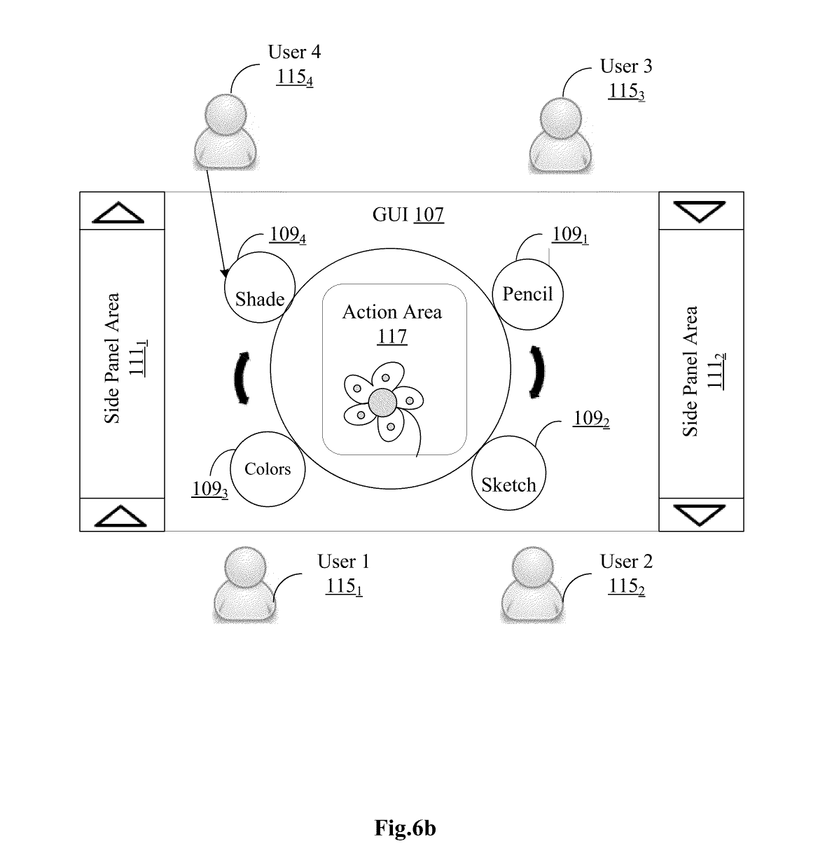

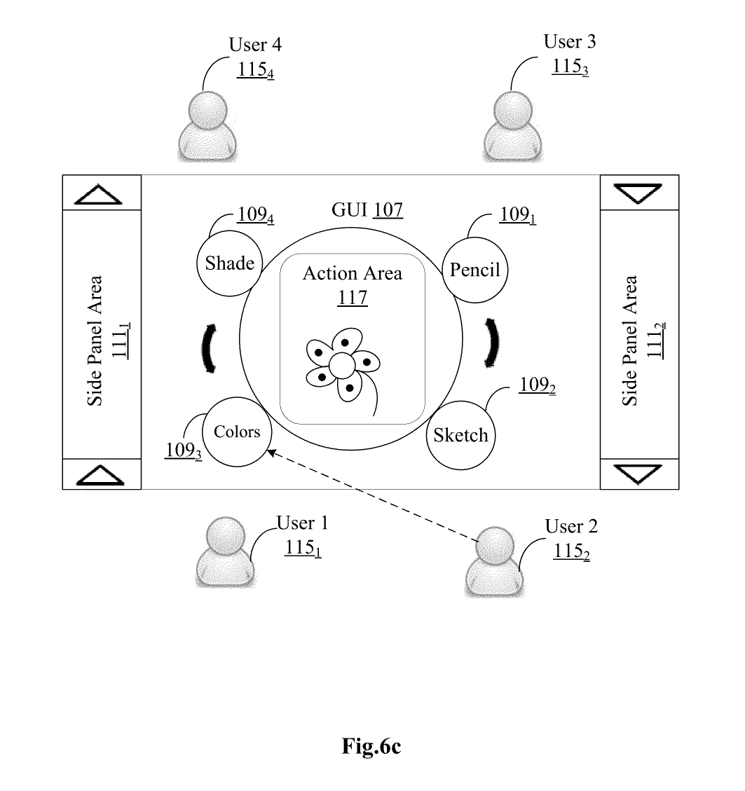

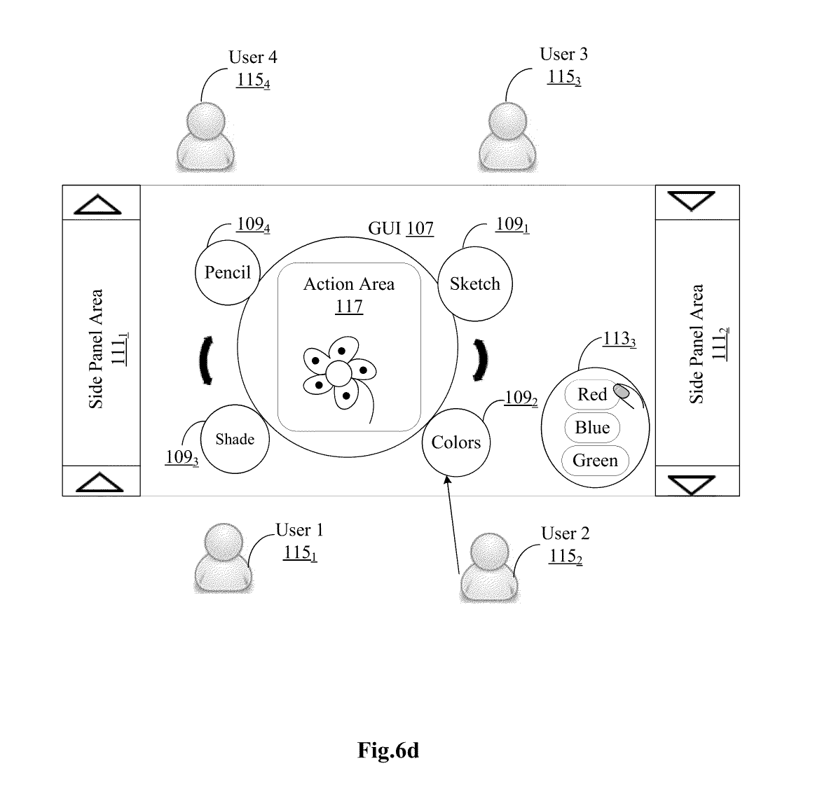

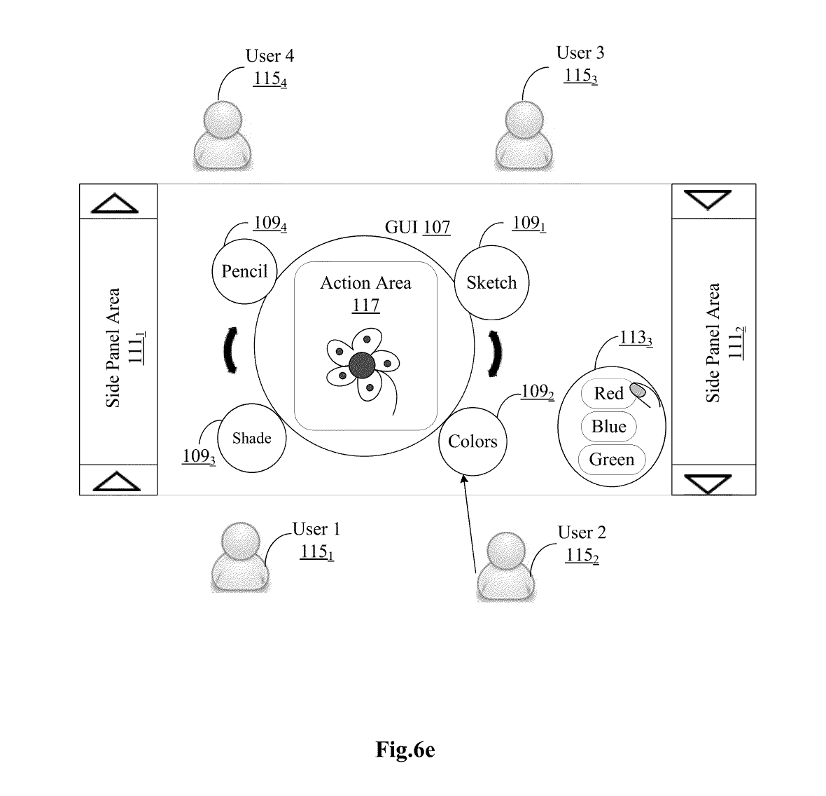

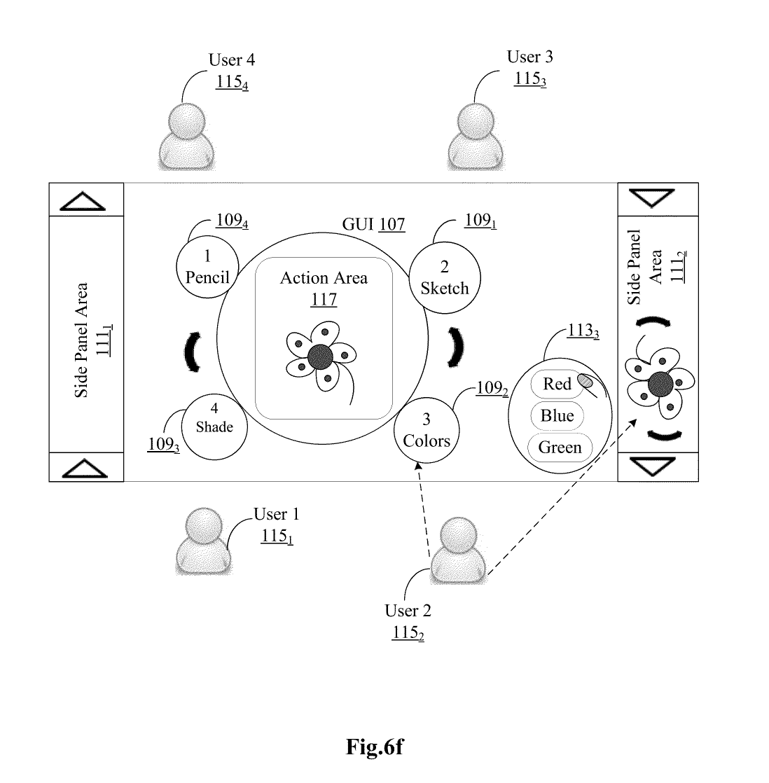

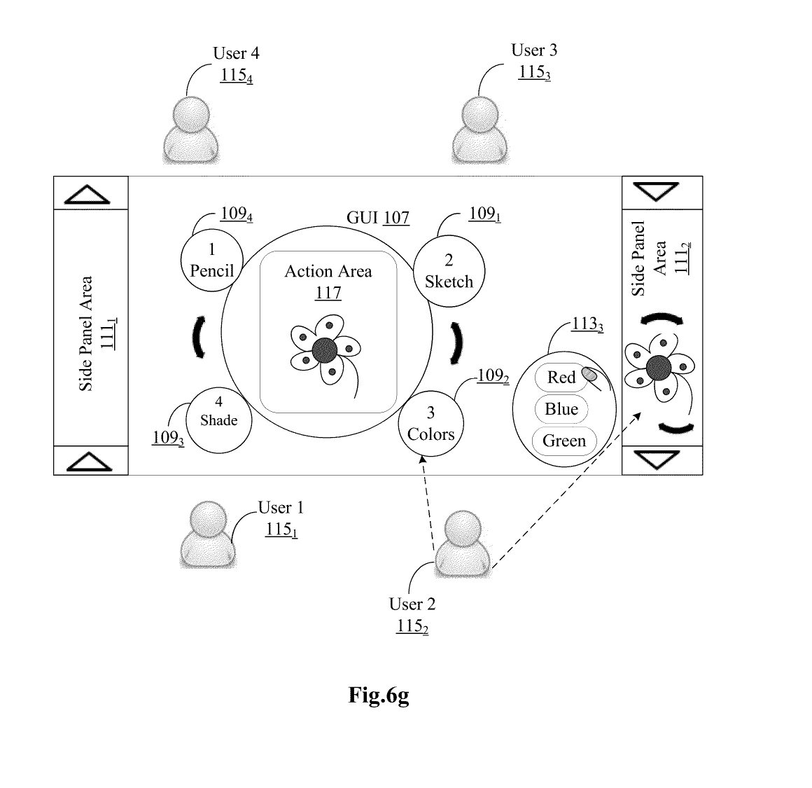

FIGS. 6a-6e illustrates a method for enhancing interaction efficiency of a multi-user collaborative GUI 107 in accordance with some exemplary embodiments of the present disclosure.

As shown in FIG. 6a, the one or more users, user 1 115₁, user 2 115₂, user 3 115₃ and user 4 115₄ interact with the GUI 107. As an example, the application being executed in the device 100 is for creating a drawing wherein one or more users interact with the GUI 107 for creating the drawing. The processing unit 101 displays the object of interest on the action area 117. The object of interest is the drawing canvas being displayed on the action area 117. The image of a flower is provided in the drawing canvas. Thereafter, the processing unit 101 displays the one or more menu icons 109 on the periphery of the action area. The one or more menu icons 109 correspond to the one or more actions associated with the object of interest. The one or more menu icons which correspond to the one or more actions associated with the object of interest are menu icon pencil 109₁, menu icon sketches 109₂, menu icon color 109₃ and the menu icon shade 109₄.

As shown in FIG. 6b, the user 4 115₄, selects the menu icon shade 109₄. The processing unit 101 detects the selection of the menu icon shade 109₄ and applies the action associated with the menu icon shade 109₄ on to the object of interest which is flower. The processing unit 101 processes the object of interest based on the applied action i.e. the action of providing a shade effect to the flower is performed to obtain a processed object. The processed object is a shaded flower, which is displayed on the action area 117. In some embodiments, the processing unit 101 may display the shaded flower on the side panel area 111₁. The user may orient the shaded flower in one or more directions.

In one implementation, the processing unit 101 display the processed object onto the action area 117 wherein the one or more users may perform one or more actions on the processed object.

As shown in FIG. 6c, the user 2 115₂ may intend to select the menu icon color 109₃. But since the menu icon color 109₃ is far away from the reach of the user 2 115₂, the user 2 115₂ may rotate the one or more menu icons 109 in anti-clockwise direction. By rotating the one or more menu icons 109 in anti-clockwise direction, the menu icon color 109₃ is near the position of the user 2 115₂.

As shown in FIG. 6d, the user 2 115₂ may select the menu icon color 109₃. The processing unit 101 detects the selection of the menu icon color 109₃. The processing unit 101 detects that the menu icon color 109₃ is associated with a movable sub-menu icon 113₃. The processing unit 101 displays the movable sub-menu icon 113₃ on the GUI 107. The user 2 115₂ may move the movable sub-menu icon 113₃ towards the position of the user 2 115₂. The movable sub-menu icon 113₃ includes three colors namely red, blue and green. The user 2 115₂ may select the red color. The processing unit 101 detects the selection of the movable sub-menu icon 113₃. Thereafter, the processing unit 101 performs the action associated with the selected movable sub-menu icon 113₃ on the object of interest. The processing unit 101 processes the flower based on the selected color to obtain a processed object i.e. the flower with red color is obtained. The red-color flower is displayed on the action area 117 as shown in FIG. 6e. In some embodiments, the processing unit 101 may display the processed object on either of the side panel area 111. The user 2 115₂ may orient the processed object displayed on the side panel area 117 in one or more directions. For example, the processed object may be displayed on the second side panel area 111₂ as shown in the FIG. 6f. The user 2 115₂ may rotate the processed object in one or more directions. For example, the user 2 115₂ may rotate the proceeded object in clock-wise direction and the processed object after rotation is as shown in the FIG. 6g.

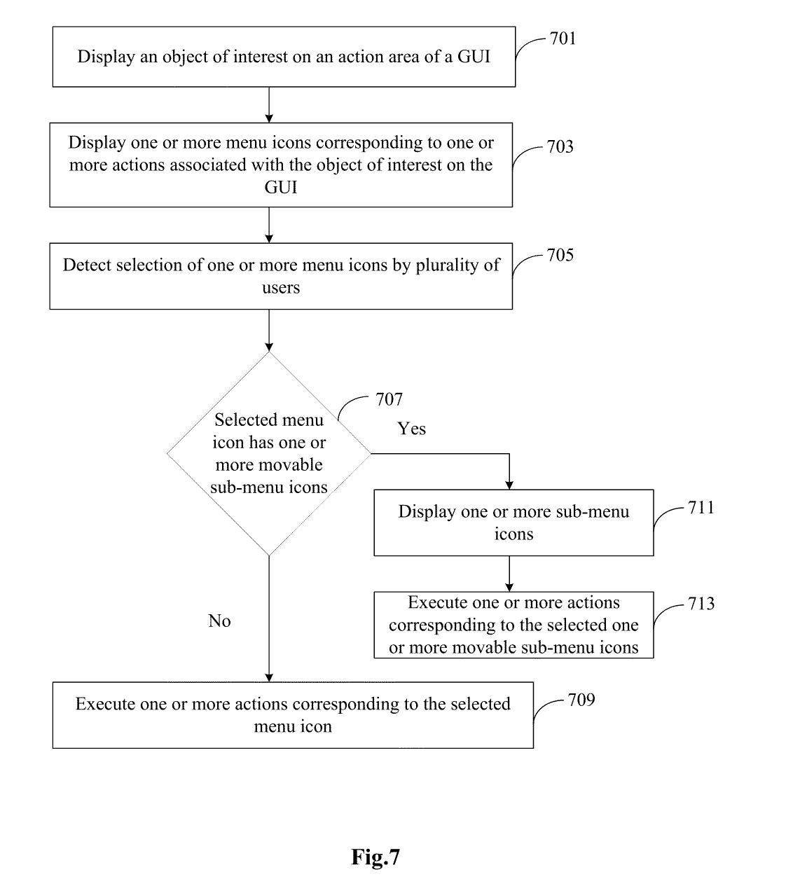

FIG. 7 illustrates a flowchart of method of enhancing interaction efficiency of a multi-user collaborative GUI 107 in accordance with some other embodiments of the present disclosure.

As illustrated in FIG. 7, the method comprises one or more blocks for enhancing interaction efficiency of a multi-user collaborative GUI 107. The method may be described in the general context of computer executable instructions. Generally, computer executable instructions can include routines, programs, objects, components, data structures, procedures, modules, and functions, which perform particular functions or implement particular abstract data types.

The order in which the method is described is not intended to be construed as a limitation, and any number of the described method steps can be combined in any order to implement the method. Additionally, individual steps may be deleted from the method without departing from the spirit and scope of the subject matter described herein. Furthermore, the method can be implemented in any suitable hardware, software, firmware, or combination thereof.

At step 701, an object of interest is displayed on an action area 117 of the GUI 107. In one embodiment, the processing unit 101 displays an object of interest on an action area of the GUI 107. The object of interest is common to plurality of users interacting with the GUI 107. The object of interest is based on the application being executed in the device 100.

At step 703, one or more menu icons are displayed on the GUI 107. In one embodiment, the processing unit 101 displays the one or more menu icons 109 on the GUI 107. The one or more menu icons 109 correspond to one or more actions associated with the object of interest. The one or more menu icons 109 are displayed on either periphery of the action area 117 or on the boundary of the action area 117. The one or more menu icons 109 are rotatable in either clock-wise direction or anti-clockwise direction. The one or more users 115 interacting with the multi-user collaborative GUI 107 may rotate the one or more menu icons 109 such that the intended menu icons are near the position of the user i.e. the user don't have to move around the GUI 107 for interacting with the GUI 107. The GUI 107 orients itself based on the specific needs of the user and without obstructing other user's interactions with the GUI 107.

At step 705, the processing unit 101 detects selection of one or more menu icons 109 by plurality of users 115. In one embodiment, the plurality of users 115 may select one or more menu icons 109 displayed on the GUI 107. The processing unit 101 detects the selection of the one or more menu icons 109 and process the one or more actions corresponding to the selected one or more menu icons 109.

At step 707, the one or more menu icons 109 are checked for one or more movable sub-menu icons. In one embodiment, the processing unit 101 determines whether the selected one or more menu icons 109 are associated with one or more movable sub-menu icons. In one embodiment if the determination at step 707 follows the “NO” loop, then the method proceeds to step 709 via “No”. If the determination is “TRUE”, then the method proceeds to step 711 via “Yes”.

At step 709, execute one or more actions corresponding to the selected menu icon 109. In one embodiment, the processing unit 101 applies the one or more actions on the object of interest to obtain a processed object. The processed object may be further displayed on the action area 117 for performing one or more further actions.

At step 711, one or more movable sub-menu icons are displayed on the GUI 107. In one embodiment, the processing unit 101 displays one or more movable sub-menu icons on the GUI 107. The one or more movable sub-menu icons are movable across the GUI 107. Upon receiving a signal from the user, the processing unit 101 moves the movable sub-menu icons to the position of the users. The one or more movable sub-menu icons correspond to one or more actions associated with the object of interest. The user may select one or more movable sub-menu icons.

At step 713, one or more actions corresponding to the selected one or more movable sub-menu icons are displayed. In one embodiment, the processing unit 101 detects the selection of the one or more movable sub-menu icons. Thereafter, the processing unit 101 applies the one or more actions corresponding to the selected one or more movable sub-menu icons on the object of interest to obtain a processed object. The processed object is displayed on the action area 117. In some embodiments, the processed object may be displayed on either of the side panel area configured in the GUI 107.

The specification has described a method and a system for optimizing execution of test cases. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processing unit may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for enhancing interaction efficiency of multi-user collaborative graphical user interface (GUI), the method comprising:
displaying, by a processing unit of a computing device, an object of interest on an action area of a GUI on a display device of the computing device, wherein the object of interest is common to plurality of users interacting with the GUI;
displaying, on the display device by the processing unit of the computing device, one or more menu icons corresponding to one or more actions associated with the object of interest, wherein the one or more menu icons are rotatable in at least one of clockwise and anti-clockwise directions;
detecting, by the processing unit of the computing device, a selection of the one or more menu icons on the display device of the computing device by one of the plurality of users, wherein the selection of one or more menu icons causes the processing unit to perform at least one of:
displaying, on the display device of the computing device, one or more movable sub-menu icons corresponding to one or more actions associated with the object of interest; or
executing, by the processing unit of the computing device, the one or more actions corresponding to the selected one or more menu icons on the object of interest to obtain a processed object.

2. The method as set forth in claim 1 further comprising displaying, on the display device by the processing unit of the computing device, the processed object on at least one side panel area of the GUI, wherein the processed object is orientable in one or more directions.

3. The method as set forth in claim 1, wherein the one or more menu icons are displayed on at least one of boundary of the action area and periphery of the action area on the display device of the computing device.

4. The method as set forth in claim 1, wherein the one or more movable sub-menu icons is configured by the processing unit for movement across the GUI on the display device of the computing device.

5. The method as set forth in claim 1 further comprising:
detecting, by the processing unit of the computing device, a selection of the one or more movable sub-menu icons on the display device of the computing device by one of the plurality of users; and
executing, by the processing unit of the computing device, the one or more actions corresponding to the selected one or more movable sub-menu icons on the object of interest to obtain the processed object.

6. A device for enhancing interaction efficiency of multi-user collaborative graphical user interface (GUI), the device comprising:
a multi touch screen display configured to be responsive to an input element interacting with the GUI displayed on the touch screen display;
at least one processing unit; and
a memory storing programmed instructions executable by the at least one processor, wherein the instructions configure the at least one processing unit to:
display an object of interest on an action area of the GUI configured in the touch screen display, wherein the object of interest is common to plurality of users interacting with the GUI;
display one or more menu icons corresponding to one or more actions associated with the object of interest, wherein the one or more menu icons are rotatable in at least one of clockwise and anti-clockwise directions;
detect a selection of the one or more menu icons by one of the plurality of users, wherein the selection of one or more menu icons causes the processing unit to perform at least one of:
display one or more movable sub-menu icons corresponding to one or more actions associated with the object of interest; or
execute the one or more actions corresponding to the selected one or more menu icons on the object of interest to obtain a processed object.

7. The device as set forth in claim 6, wherein the processing unit is further capable of displaying the processed object on at least one side panel area of the GUI.

8. The device as set forth in claim 7, wherein the processing unit is capable of orienting the processed object in one or more directions.

9. The device as set forth in claim 6, wherein the processing unit is further capable of:
detecting selection of the one or more movable sub-menu icons by one of the plurality of users; and
executing the one or more actions corresponding to the selected one or more movable sub-menu icons on the object of interest to obtain the processed object.

10. The device as set forth in claim 6, wherein the processing unit is further capable of displaying one or more menu icons on at least one of boundary of the action area and periphery of the action area.

11. The device as set forth in claim 6, wherein the one or more movable sub-menu icons is configured for movement across the GUI.

12. A non-transitory computer readable medium having stored thereon instructions for enhancing interaction efficiency of multi-user collaborative graphical user interface (GUI) comprising machine executable code which when executed by a processor, causes the processor to perform steps comprising:
displaying an object of interest on an action area of the GUI, wherein the object of interest is common to plurality of users interacting with the GUI;
displaying one or more menu icons corresponding to one or more actions associated with the object of interest, wherein the one or more menu icons are rotatable in at least one of clockwise and anti-clockwise directions;
detecting selection of the one or more menu icons by the plurality of users, wherein the selection of one or more menu icons causes the processing unit to perform at least one of:
displaying one or more movable sub-menu icons corresponding to one or more actions associated with the object of interest; or
executing the one or more actions corresponding to the selected one or more menu icons on the object of interest to obtain a processed object.

13. The medium as set forth in claim 12 further comprising displaying the processed object on at least one side panel area of the GUI, wherein the processed object is orientable in one or more directions.

14. The method as set forth in claim 12, wherein the one or more menu icons are displayed on at least one of boundary of the action area and periphery of the action area.

15. The method as set forth in claim 12, wherein the one or more movable sub-menu icons is configured for movement across the GUI.

16. The method as set forth in claim 12 further comprising:
detecting a selection of the one or more movable sub-menu icons by one of the plurality of users; and
executing the one or more actions corresponding to the selected one or more movable sub-menu icons on the object of interest to obtain the processed object.
